(19) United States
(12) Patent Application Publication
(10) Pub. No.: US 2008/0155034 A1
(43) Pub. Date: Jun. 26, 2008

(54) METHOD FOR PROVIDING CONTAINER AWARE FORM FORMAT, ACTION, AND SECURITY

(75) Inventors: Li Chen, Cary, NC (US); John R. Hind, Raleigh, NC (US); Yongcheng Li, Cary, NC (US); Lun Xiao, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/615,041

(22) Filed: Dec. 22, 2006

(51) Int. Cl. G06F 15/16

(52) U.S. Cl. 709/206

(57) ABSTRACT

A method, article, and system to implement software that manages information transfer and interaction, and more particularly to providing a method, article, and system for utilizing “Forms” in a User2User (U2U) environment, such as instant messaging (IM). A “Container Aware Form” (CAF) is provided and embedded within the U2U mode, where the “Form” is aware of the endpoint container in which the user views them. In an IM application, the IM can differentiate form view format, action, and security when the same form is displayed in different IM containers. The present invention combines the benefits of U2U instant communication with information automation for all parties involved in an interaction.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to software that manages information transfer and interaction, and more particularly to providing a method, article, and system for utilizing “Forms” in a User2User (U2U) environment, such as instant messaging (IM). A “Container Aware Form” (CAF) is provided and embedded within the U2U mode, where the “Form” is aware of the endpoint container in which the user views them.

2. Description of the Related Art

“Forms” are a common and efficient method of automatically performing organized actions and efficiently transferring structured information. Up to now they have been used in a client/server environment, with a user interacting with an application, workflow, manager, or other non-human automation.

Common software currently available for the client/server environment include the Xforms standard, Adobe® LiveCycle™ Forms, Microsoft® InfoPath 2003™, and Lotus Notes™ with Lotus Script™ automated documents

However none of these software solutions provide a “User2User” (U2U) means of orchestrating action and transferring structured information. One of the growing U2U paradigms today is that of “Instant Messaging” (IM) and hence a need for “Forms” which can operate in this U2U mode that is to say they are aware of the endpoint container in which a user views them.

The present invention is directed to addressing, or at least reducing, the effects of, one or more of the problems set forth above, by providing a method, article, and system for utilizing “Forms” in a User2User (U2U) environment, such as instant messaging (IM). A “Container Aware Form” (CAF) is provided and embedded within the U2U mode, where the “Form” is aware of the endpoint container in which the user views them.

### SUMMARY OF THE INVENTION

Embodiments of the present invention comprise a method for managing information transfer and interaction in a system utilizing Container Aware Forms (CAF) in a User2User (U2U) environment, where the system comprises: software; user interfaces; and at least one network. The users within the system are both senders and receivers of the information. The CAF is implemented in software, with the CAF embedded in the U2U environment. The CAF is aware of the endpoint container used in the user interface in which the user views and interacts with the CAF, and based on the endpoint container the form view format, action, and security will be determined and conveyed to the user. The U2U environment comprises application modes, wherein the application modes further comprise instant messaging (IM). The CAF comprise fields, which determine actions required by the users and the system, wherein the fields vary depending on if it is received in a receiver or a sender's container. The CAF may also comprise fields with an action link. The action link can pre-populated the fields with information from the system; and depending on if the CAF is received in the receiver or the sender's container, the pre-populated fields may or may not be visible to the user. The security based on the container involves the user assigning a signature to the CAF for two-way verification of the CAF flow, which also provides for an audit trail. The CAF can be implemented in software such as Asynchronous JavaScript, XML, and XHTML. The software provides graphical user interfaces (GUIs) that interact with the CAF.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates a screen view on a user interface of an instant messaging session in which the user receives a request and responds with a CAF.

FIG. 1B illustrates a screen view of the requestor user interface with the received CAF.

FIG. 1C illustrates a screen view of the receiver user interface with the requesters filled out CAF.

FIG. 2 illustrates a system for practicing one or more embodiments of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method and system for utilizing “Forms” in a User2User (U2U) environment, such as instant messaging (IM). A “Container Aware Form” (CAF) is provided and embedded within the U2U mode, where the “Form” is aware of the endpoint container in which the user views them. In an IM application, the IM can differentiate form view format, action, and security when the same form is displayed in different IM containers. The present invention combines the benefits of U2U instant communication with information automation for all parties involved in an interaction.

The CAF of the present invention allows both the form sender and receiver(s) to see essentially the same form, however if it is desired different fields can be displayed and different actions can be taken within a specific container. For example, pressing the submit button inside the form by the form receiver will submit the data back to the form sender but (after examining the data from the form receiver) clicking the same submit button by the form sender will submit the collected data to a backend application system to process the information.

The present invention allows a form developer to include an action link in the form that is only displayed in the sender's container. What the action link does is to pre-populate some form fields by retrieving those values from a backend application system. When the form is passed to its receiver, the pre-populate link will become invisible to the form receiver. Similarly the developer can include actions in the form which are only visible to the original sender after the receiver has returned the form which may be used to post-populate fields that where invisible to the receiver (for example the directory group name from the verification action in the above scenario).

Another aspect of container aware IM-based form of the present invention is security. The form developer can embed different security actions in the form based on its container. For example, when the sender sends an empty form to the receiver, the sender will sign the control areas of the form. When the receiver sends the form back, the receiver will sign the data fields and senders signature (representing the form structure). This provides a means of two-way verification of the U2U form flow while also creating a meaningful audit trail.

One possible embodiment of the present invention would be an AJAX (Note: AJAX is shorthand for Asynchronous JavaScriptand XML, is a web development technique for creating interactive web applications. The intent is to male web pages feel more responsive by exchanging small amounts of data with the server behind the scenes, so that the entire web page does not have to be reloaded each time the user makes a change. This is meant to increase the web page's interactivity, speed, and usability.) type application running in an IM senders chat container whose scripting can request of the container that the application be “freeze dried” (serialized), transmitted over the IM channel, and “reconstituted” in the receivers chat container. The CAF of this embodiment would then be described in a markup language that has similarity to the way one would describe a scripted form in XHTML. In additional embodiments of the present invention, the CAF can be facilitated with software utilizing document object friendly scripting languages including, but not limited to, JavaScript and VisualBasic.

An example of a U2U information automation scenario employing the present invention is as follows.

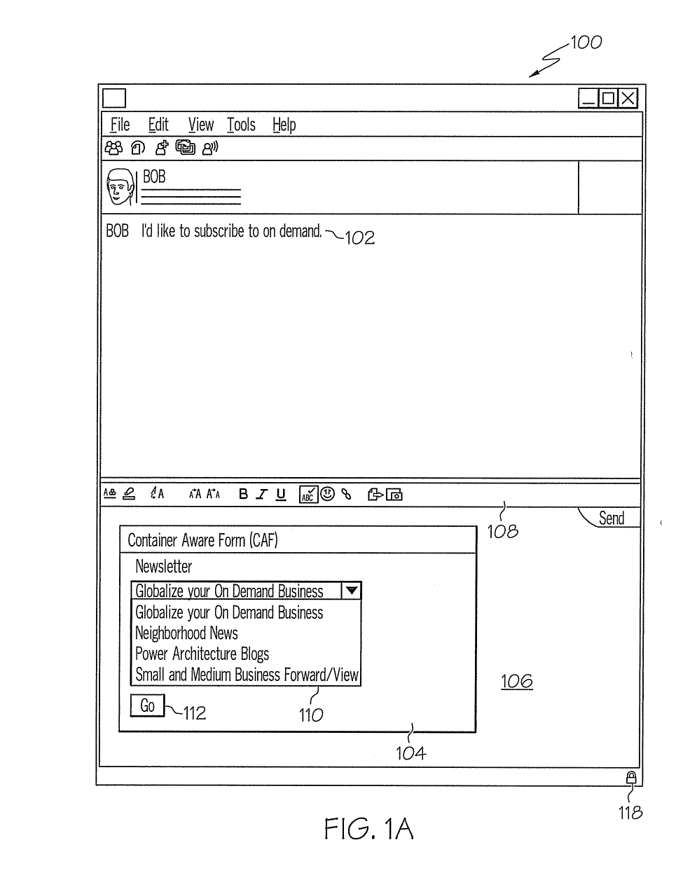

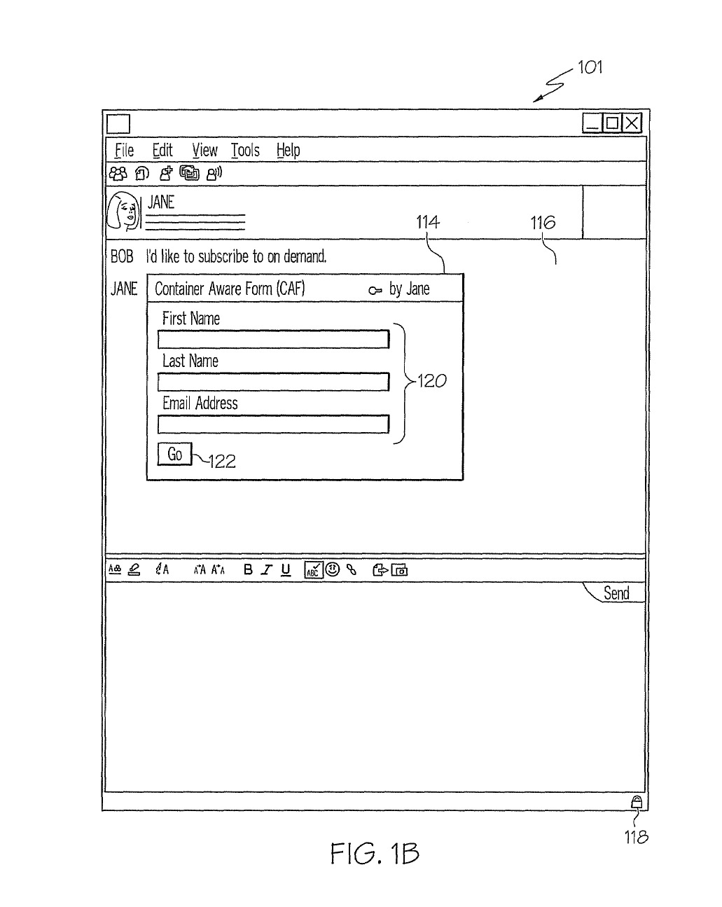

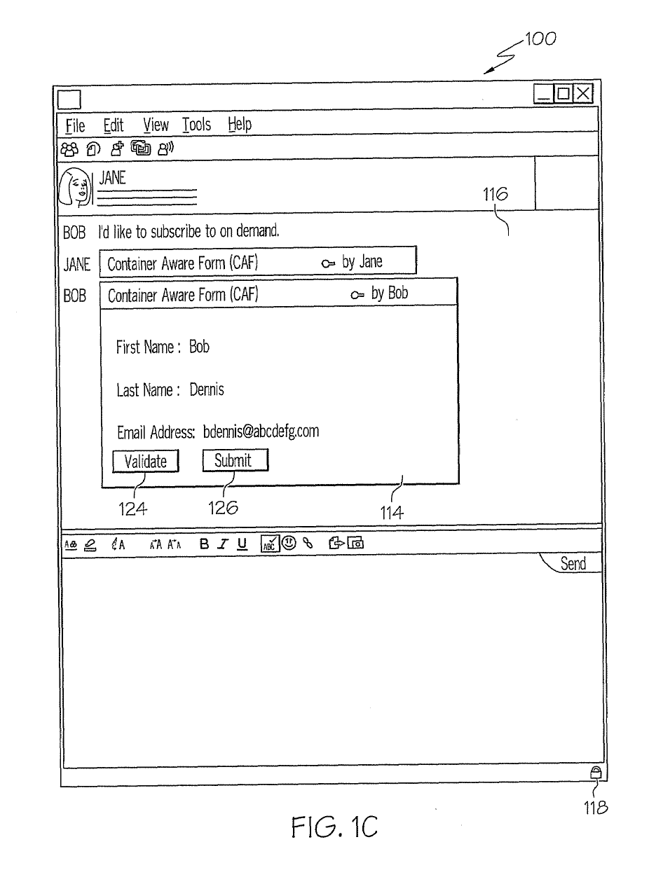

FIGS. 1A, 1B and IC illustrate the implementation CAF in an IM (100, 101) session. In FIG. 1A a user (named BOB in the example) sees a copy of a newsletter that becomes of interest to the user. The user IMs the author (named Jane in the example) of the newsletter asking to be included on the distribution (102). The author who edits/administers several team-ware publications drags a “Container Aware Form” (CAF) Icon 104 from a toolbar 108 onto the IM window 106, using a pull-down field selects the newsletter identity that the user asked about (110), and pushes the “GO” button 112. In FIG. 1B, the user now sees the CAF 114 in his IM client's window 116 complete with a “lock” Icon 118 indicating that the author's signature has been verified. The user fills in the fields 120 Oust as if using a browser with assist features enabled—for example, auto-complete of his name, email . . . ) and presses, “GO” 122. In FIG. 1C the author now sees the CAF 114 with a “lock” Icon 118 indicating that the user's signature of the data has been verified and that the form definition information has not been modified since the author signed it. The author presses the “validate” button 126 that is now visible in the CAF 114 to verify the user is in one of the directory groups that are allowed to access the newsletter and then clicks the “submit” button 126 to submit the CAF's data to the subscription system. Prior art system required a server to mediate in any form flow between users, and did not provide a mechanism for integrating container identity and form state as provided by the present invention

Table 1. Provides an example of the button definition code using CAF markup language to implement the user-author interaction of the previous example. The sample definition code illustrates how to define different actions and display styles associated with a button based on its container, owning form token or not, and the form trip counter.

TABLE 1
Container Aware Form Language

| | |
|---|---|
| <cafl> | |
| <button id=“go” name=“go” value=“GO”> | SECTION A |
| <style display=“block”> | |
| <trip-counter operator=“<”>2</trip-counter> | |
| </style> | |
| <action type=“send” token=“yes” container=“sender”> | |
| <trip-counter operator=“=”>0</trip-counter> | |
| </action> | |
| <action type=“send” token=“yes” container=“receiver”> | |
| <trip-counter operator=“>”>0</trip-counter> | |
| </action> | |
| </button> | |
| <button id=“submit” name=“submit” value=“SUBMIT” | SECTION B |
| url=“http://my.com/myApp/servlet/subscription”> | |
| <style display=“block” container=“sender”> | |
| <trip-counter operator=“>=”>2</trip-counter> | |
| </style> | |
| <action type=“submit” token=“no” container=“sender”> | |
| <trip-counter operator=“>=”>2</trip-counter> | |
| </action> | |
| </button> | |
| <button id=“verify” name=“verify” value=“VERIFY” | SECTION C |
| url=“http://my.com/myApp/servlet/verify”> | |
| <style display=“block” container=“sender”> | |
| <trip-counter operator=“>=”>2</trip-counter> | |
| </style> | |
| <action type=“submit” token=“no” container=“sender”> | |
| <trip-counter operator=“>=”>2</trip-counter> | |
| </action> | |
| </button> | |
| <cafl> | |

The container aware form language of Section A of Table 1 determines the display attribute of a style element to configure when the button will be displayed, a value of “block” means the button will be displayed, while a value of “none” indicates the button will be hidden. The action element describes the action to be invoked when the button is clicked. The “send” type of an action means the form will be transmitted to the communication partner. The “submit” type means that the form will be submitted to an URL for processing. The token attribute indicates whether a token representing the signature of the IM user is required for true origin verification. A value of “yes” means the token is required with the form. The container field indicates the container in which the action should be activated and performed. The trip-counter element defines the condition in which the action is valid depending on how many times the form has been exchanged between the sender and the receiver. A button is defined with an id and name of “go”, and a display value of “GO”. The button is only visible when its number of trips between the sender and receiver is less than 2 (the default trip-counter of a form is 0). There are two actions associated with the “go” button. One is defined for the sender when the form is first created (trip-counter is 0). When the button is clicked, the form will be sent to the receiver. Another action is defined for the receiver container with the same type of “send” action when the trip-counter is greater than 0.

The container aware form language of Section B of Table 1 defines a “submit” button that will only be displayed when the sender receives the filled form from the receiver (trip-counter is great than 2) with an action of submit the form to an URL for further processing.

The container aware form language of Section C of Table 1 defines a “verify” button that will only be displayed when the sender receives the filled form from the receiver (trip-counter is great than 2) with an action of submit the form to an URL for further processing.

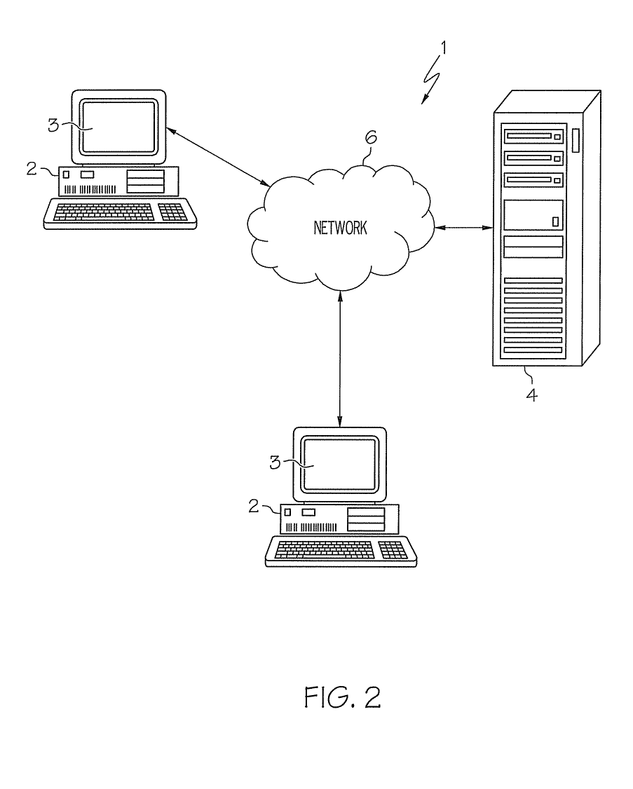

FIG. 2 is a block diagram of an exemplary system for implementing the “Container Aware Form” of the present invention and graphically illustrates how those blocks interact in operation. The system includes one or more computing/communication devices 2 coupled to a server system 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (for example, Internet), intranet, wireless or cellular network, etc. The computing/communication devices 2 may be coupled to the server system 4 through multiple networks (for example, intranet and Internet) so that not all computing/communication devices 2 are coupled to the server system 4 via the same network. In a preferred embodiment, the network 6 is a LAN and each computing/communication device 2 executes a user interface application (for example, web browser) to contact the server system 4 through the network 6. Alternatively, a computing/communication device 2 may be implemented using a device programmed primarily for accessing network 6 such as a remote client. A display means 3 is provided for the user to interact with the “Container Aware Form” program.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing information transfer and interaction utilizing Container Aware Forms (CAF) in a User2User (U2U) environment within a system, where the CAF is aware of a endpoint container on a user interface, in which one or more users view and interact with the CAF, wherein the method comprises:
facilitating the implementation of the CAF via software;
facilitating the embedding of the CAF in the U2U environment; and
facilitating the CAF to respond to the endpoint container, where the CAF form view format, action, and security will be determined and conveyed to the one or more users.

2. The method of claim 1, wherein:
the facilitating of the CAF involves application modes within the U2U environment; and
the application modes further comprise instant messaging (IM).

3. The method of claim 1, wherein:
the responding of the CAF is facilitated by fillable fields;
content of the fillable fields vary depending on the endpoint container; and
the fillable fields determine the actions required by the one or more users.

4. The method of claim 1, wherein:
the responding of the CAF is facilitated by fillable fields;
content of the fillable fields vary depending on the endpoint container; and
the fillable fields determine the actions required by the system.

5. The method of claim 1, wherein:
the responding of the CAF is facilitated by fillable fields and an action link;
the action link configured to pre-populated the fillable fields with information from the system; and
in response to the endpoint container the CAF determines if the pre-populated fillable fields are visible to a user of the one or more users.

6. The method of claim 1, wherein:
the determining of security, in response to the CAF responding to the endpoint container, involves the user assigning a signature to the CAF for two-way verification of a CAF flow.

7. The method of claim 1, wherein:
the determining of security, in response to the CAF responding to the endpoint container, involves the user assigning a signature to the CAF for two-way verification of a CAF flow; and
wherein the verification provides an audit trail.

8. The method of claim 1, wherein:
the implementing of the CAF comprises executing a document object friendly scripting language.

9. The method of claim 8, wherein:
the document object friendly scripting language is Asynchronous JavaScript, VisualBasic, or both.

10. The method of claim 1, wherein:
the implementing of the CAF is facilitated with software comprising XML and XHTML.

11. The method of claim 1, wherein:
the implementing of the CAF is facilitated with software that implements graphical user interfaces (GUIs) that interact with the CAF.

12. An article comprising machine-readable storage media containing instructions that when executed by a processor enable a processor to manage information transfer and interaction in a system utilizing Container Aware Forms (CAF) in a User2User (U2U) environment, wherein the system comprises: computer servers, mainframe computers, and user interfaces, and wherein the user interfaces further comprise: desktop computers, laptop computers, mobile computing devices, and mobile communication devices.

13. The article of claim 12 wherein the CAF is aware of the endpoint container on the user interface in which one or more users view and interact with the CAF; and
wherein based on the endpoint container the form view format, action, and security will be determined and conveyed to the one or more users.

14. The article of claim 12 wherein the U2U environment comprises application modes; and
wherein the application modes further comprise instant messaging (IM).

15. The article of claim 12 wherein the CAF comprises fillable fields;
content of the fillable fields vary depending on the endpoint container; and
wherein the fillable fields determine the actions required by the one or more users and the system.

16. The article of claim 12 wherein the CAF comprises fillable fields and an action link;
wherein the action link can pre-populated the fillable fields with information from the system; and
in response to the endpoint container the CAF determines if the pre-populated fillable fields are visible to the one or more users.

17. The article of claim 12 wherein the instructions are facilitated with a document object friendly scripting language.

18. The article of claim 17 wherein the document object friendly scripting language is Asynchronous JavaScript, VisualBasic, or both.

19. The article of claim 12 wherein the instructions are facilitated with at least one of the following: XML and XHTML.

20. A system for managing information transfer and interaction utilizing Container Aware Forms (CAF) in a User2User (U2U) environment;
wherein the system comprises computing devices and a network; and
wherein the computing devices further comprise at least one of the following:
computer servers;
mainframe computers;
desktop computers; and
mobile computing devices; and
wherein at least one of the computing devices is configured to execute electronic software that manages the CAF; and
wherein the electronic software is resident on a storage medium in signal communication with the network; and
wherein at least one of the computing devices is in signal communication with the network; and
wherein the network further comprises at least one of the following:
local area network (LAN);
wide area network (WAN);
a global network;
the Internet;
a intranet;
wireless networks; and
cellular networks; and
wherein the CAF responds to an endpoint container, where the CAF form view format, action, and security will be determined and conveyed to one or more users.
